(19) United States
(12) Patent Application Publication
(10) Pub. No.: US 2014/0058844 A1
(43) Pub. Date: Feb. 27, 2014

(54) DEMOGRAPHICS WEBSITE

(71) Applicants: Anita Jadeja, Cherrybrook (AU); Dilipsinhji Umedsinhji Jadeja, Cherrybrook (AU)

(72) Inventors: Anita Jadeja, Cherrybrook (AU); Dilipsinhji Umedsinhji Jadeja, Cherrybrook (AU)

(21) Appl. No.: 13/967,835

(22) Filed: Aug. 15, 2013

(30) Foreign Application Priority Data
Aug. 15, 2012 (AU) 2012903511

(51) Int. Cl. G06Q 30/02; G06Q 50/00

(52) U.S. Cl. CPC G06Q 30/0269; G06Q 50/01
USPC 705/14.66; 705/319

(57) ABSTRACT

An information portal and method is provided. The portal comprises a computing apparatus that stores user information, the computing apparatus being connected to a data network, and a plurality of user accounts stored in computing apparatus memory and accessible through the data network, each user account being linked to a corresponding user's information. The computing apparatus supports an interface that facilitates user interaction with the information portal, the interface enabling users to enter their own user information and assign a disclosure rule to individual information entries comprising the user information, and the computing apparatus applies the disclosure rules to govern access by third parties to the user information.

### FIELD OF THE INVENTION

The invention relates to online networking and advertising systems.

### BACKGROUND TO THE INVENTION

Online social networks allow people to interact with their friends and family without having to meet in the same spatial location. Websites such as Facebook™, Myspace™ and Bebo™ provide a framework for people to communicate and share information online. These tools allow people to stay in touch despite geographical separation and busy schedules by providing a common meeting place.

### SUMMARY OF THE INVENTION

An information portal is disclosed in this specification, the portal comprises a computing apparatus that stores user information, the computing apparatus being connected to a data network, and

a plurality of user accounts stored in computing apparatus memory and accessible through the data network, each user account being linked to a corresponding user's information,

wherein the computing apparatus supports an interface that facilitates user interaction with the information portal, the interface enabling users to enter their own user information and allocate a disclosure rule to individual information entries comprising the user information, and the computing apparatus applies the disclosure rules to govern access by third parties to the user information.

In an embodiment, the user may set already available disclosure rules which are made available to them by the information portal. In an embodiment, the user may assign disclosure rules that they may define themselves. In an embodiment, the information portal may enable the setting by the user of disclosure rules that are available on the portal and enable the user to define and assign their own user defined disclosure rules.

In an embodiment, the computing apparatus may allocate disclosure rules.

In an embodiment, the allocation of disclosure rules by the user or the computing apparatus may comprise the step of allocating a timeframe for which the information will be available to third parties.

In some embodiments the portal further comprises a reward module that allocates user rewards, the reward module determining the reward allocated to a user based on the information the user has contributed to the portal.

In some embodiments, the portal further comprises an anonymous instrument that enables the user to interact with third parties without revealing their identity, the instrument being distributed to the third party to facilitate the interaction.

There is also disclosed a method comprising:

receiving information from a user,

storing the information in computer memory in association with a corresponding user account, and

issuing an anonymous instrument that enables the user to interact with third parties without revealing their identity, the instrument being distributed to the third party to facilitate the interaction.

5

### BRIEF DESCRIPTION OF THE DRAWINGS

FIG. 1 is a schematic representation of an example of an information portal comprising a computing apparatus, plurality of client computing systems and a data network.

FIG. 2 is a functional overview of an example of the services and interactions facilitated by an information portal.

FIG. 3 is a schematic representation of an example of a user interface depicting the general structure of user information within an information portal.

FIG. 4 is a schematic representation of an example of the user interface illustrated in FIG. 3 with various information fields defined within the concentric information zones.

FIG. 5 is a schematic representation of an example of another user interface with the information zones shaded to graphically represent the graduated disclosure rules.

FIG. 6 is a schematic representation of an example of a user interface depicting the types of information that a user link to the ‘closed’ information zones.

FIG. 7 is a schematic representation of an example of a user interface depicting various information fields defined within the concentric information zones.

FIG. 8 is a schematic representation of an example of an organisation user interface. The interface shares many of the attributes of the interface illustrated in FIG. 3.

FIG. 9 is a schematic representation of an example of an organisation user interface. The interface shares many of the attributes of the interface illustrated in FIG. 7.

FIG. 10 is a flow chart representation of some of the service functions provided by an embodiment of the information portal.

FIG. 11 is a flow chart representation of how the information portal may interact with third parties that request user information and interaction.

FIGS. 12 to 15 are schematic representations of examples of alternative user interfaces.

FIG. 16 is a schematic representation of an alternative user interface depicting the same information zones as FIG. 3.

FIG. 17 is a schematic representation of a further alternative user interface depicting the same information zones as FIG. 3.

### DETAILED DESCRIPTION

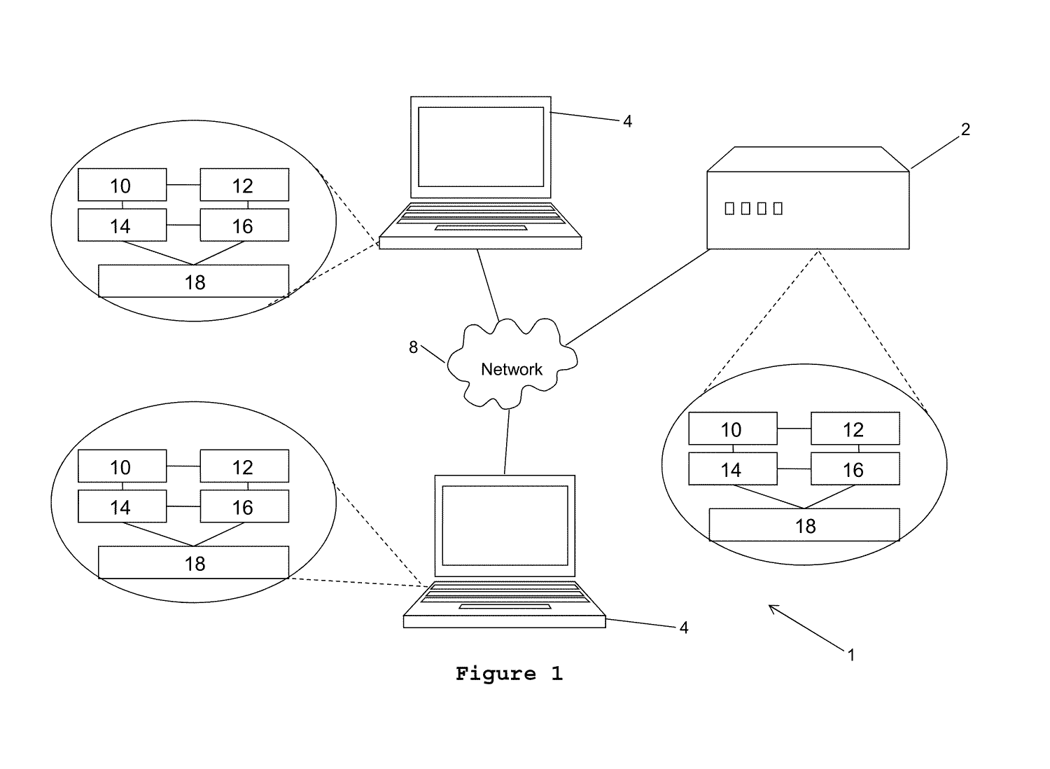

An information portal is illustrated schematically in FIG. 1. The portal 1 comprises a computing apparatus 2 that stores user information. The user information may include information indicating and related to an individual's interests (such as sports, hobbies etc), contact information (such as phone number, physical address etc) and plans for the future (home renovations, holidays etc). User information includes information that a user contributes to the portal 1 and information that the portal retrieves from other sources. The computing apparatus 2 may source user information from a corresponding user (by direct user-initiated upload or another suitable compilation procedure) or indirectly from another party. The information portal 1 may reward users for contributing personal information to the computing apparatus 2.

The computing apparatus 2 is connected to a data network 8. The data network 8 enables users to access the computing apparatus 2. The illustrated data network 8 connects the computing apparatus 2 to a plurality of client computing systems 4. The clients 4 provide an interface that enables a user to interact with the computing apparatus 2. The computing apparatus 2 may host a user interface that is accessed by client computing systems 4 operating a compatible web browser or other suitable user software.

The computing apparatus 2 and client computing systems 4 may be implemented using any suitable computing architecture, such as a cloud-based system, a virtual machine operating on shared hardware, a dedicated hardware machine or a computing apparatus bank of connected hardware and/or virtual machines. Any suitable computing devices including mobile devices may be used to implement aspects of embodiments of the invention. The computing apparatus functionality and client computing system functionality may be embodied in processor readable tangible media or coded program instructions which, when executed, cause the computing apparatus to perform the method steps described herein. The program generally, but not necessarily comprises a plurality of software modules that cooperate when installed on the processor or processors so that the steps of a method are performed. The term ‘computing apparatus’ in this specification represents general computing system functionality and is not limited to a particular type of computing architecture.

The illustrated computing apparatus 2 and client 4 computing systems are associated with hardware resources that include a processor 18, volatile memory 16 (such as random access memory or RAM), non-volatile memory 12, a network interface 10 and a bus controller 14. The hardware resources enable the computing apparatus 2 and clients 4 to perform their respective functions.

Individual user information is stored within user accounts. The illustrated information portal comprises a plurality of user accounts that are stored in computing apparatus memory. The user accounts are accessible through the data network 8 so that a user can access their information, upload additional information and change information access settings. Each user account is linked to the corresponding user's information so that the computing apparatus 2 retains a correlation between a user and their user information they have contributed to the portal 1, but may also include information from other sources.

The figures show graphical representations of information handling in embodiments of the system to assist the reader in understanding aspects of the invention. Embodiments, interfaces and forms, looks and layouts of presentations on the portal described by various figures and descriptions herein are by way of examples only. Any of these or other alternative forms alone or in any combination may be suitably used to perform method or methods disclosed herein. Any of the various features of each of the disclosures herein, any of the various features of embodiments described herein, any types of interfaces described herein and any form, looks and layout of presentation on the portal described herein can be combined as suitable and desired.

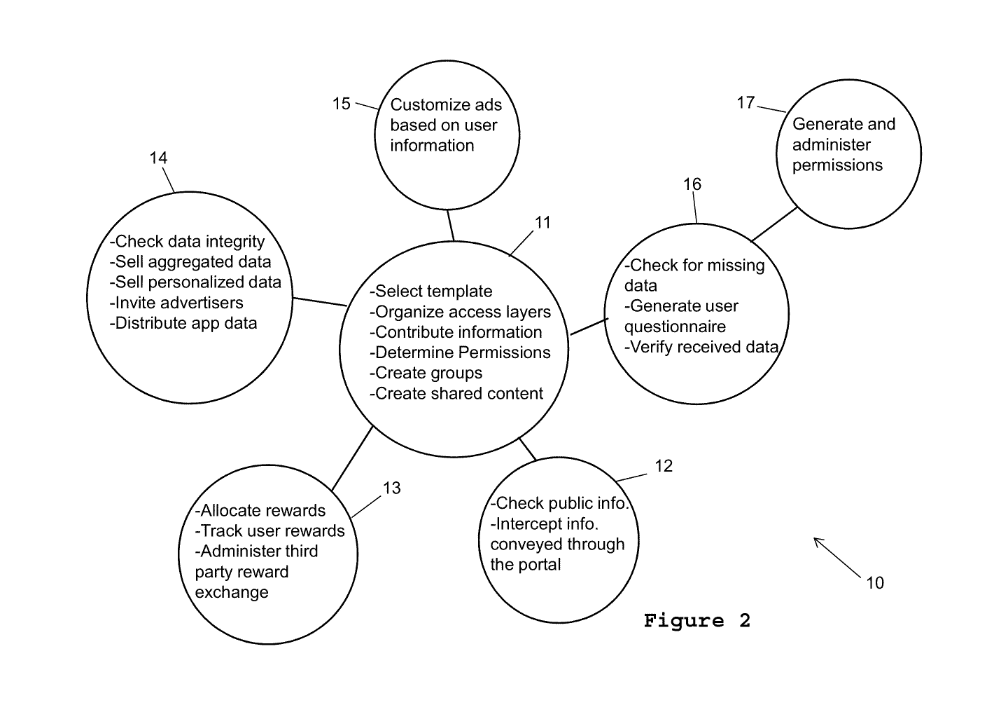

Each user account defines a plurality of disclosure rules for user information. The disclosure rules govern access to user information by third parties. The computing apparatus 2 may allocate a disclosure rule to individual information entries that comprise the user information so that a user can regulate third-party access to the user information. Each information entry may be associated with a disclosure rule, so that a user has control over the disclosure of each information entry stored on the computing apparatus 2. The generation and administration of disclosure rules (user permissions) is represented in branch 17 of the overview illustrated in FIG. 2.

The user interface hosted by the computing apparatus 2 may enable a user to set and monitor disclosure rules for information the user contributes to the information portal 1. A user sets a disclosure rule for each information entry they contribute to the portal 1 as they upload the information (or authorise retrieval from a secure source). The disclosure rule a user assigns to an information entry typically reflects the sensitivity of the corresponding information as perceived by the user. The computing apparatus may assign a sensitivity value to some user information. For example, the computing apparatus may associate a user's financial information (such as their bank account number, income and savings) with a sensitivity that is greater than a user's political opinion, lunch preferences or occupation.

The computing apparatus 2 may define a plurality of graduated disclosure rules that range from ‘open’ (information that a user is willing to make publicly available) to ‘closed’ (information that is securely stored and protected). Some information, for example open information, may be associated with a time limit. The time limit may define a period that the user is willing to make the information available to third parties. The time limit a user sets may reflect the information that the disclosure rule is associated with. For example, a user may decide to disclose information about a planned renovation (such as what the renovation entails, the intended renovation start date and an indication of what the user's expectations are). For example, the user may set a time limit for this information that expires on the date the renovations are scheduled to start. This enables the user to control the date that the information is released, the period that the information is released for and, in some circumstances, the third parties that are able to access the information. The computing apparatus 2 may prompt a user once the time limit has elapsed as to whether or not the information may be allocated another disclosure rule or another time limit applied.

The disclosure rules may reflect hierarchical information sensitivity (depicted as disclosure ‘levels’ in the layered interface presented in the drawings) or a user's personal disclosure preferences. For example, a user may select an email address to disclose depending on the recipient of the information.

The computing apparatus may automatically assign information that is obtained from other sources (i.e. not directly from the user) a default disclosure rule. The default disclosure rules assigned by the computing apparatus 2 may reflect how the corresponding information was obtained. For example, the computing apparatus 2 may assign publically-available information, retrieved by data mining, an ‘open’ disclosure rule as there is not restriction to accessing this information through other sources. The user has the option to view this information and change the disclosure level. The computing apparatus 2 may prompt a user to confirm or modify disclosure rules for information gathered after explicit user authorisation (such as information from a credit agency).

Third-party access to a user's information is primarily dictated by the disclosure rule allocated to the information. The user interface hosted by the computing apparatus 2 may enable a user to monitor their information (independently of how the information was sourced) and adjust the disclosure rules that are assigned to individual entries.

In an embodiment of the invention the information portal 1 also incorporates a reward module (not shown). The reward module is implemented by the computing apparatus 2 in the illustrated embodiment. The reward module allocates user rewards. The reward module may determine the reward that is allocated to a user based on the information the user has contributed to the portal and the user's participation within the portal. The rewards allocated by the reward module may include financial instruments (such as a notional share in the information portal), a voucher, a coupon, money or other rewards. The reward module may allocate the user rewards to reward users for the information they actively contribute to the computing apparatus 2.

The reward module may allocate different rewards depending on the activity that the user is being rewarded for. For example, the portal 1 may allocate a user a notional share in the information portal 1 for contributing information to the computing apparatus 2. The notional share may be a share in the company that owns or administers the portal 1. The share allocated by the reward module may be a voting share, a non-voting share or another type of suitable share that represents an ownership stake in the portal 1.

The reward module may determine the notional share allocated to a user based on the amount, accuracy method of input, disclosure rule and sensitivity of the information the user has contributed to the portal 1. The reward module may allocate users alternative rewards (including monetary rewards, digital currency, coupons, vouchers and discounts) depending on the circumstances. For example, the reward may depend on the type of information contributed by the user to the portal, or whether the user contributes non-personal information to the portal 1, or whether the portal obtains user information from another source.

A general operational overview of the information portal is presented in FIG. 2. The overview 10 depicts several user interactions and information services that the portal facilitates. An example of user interactions 11 are depicted at the centre of the overview. The illustrated interactions include initial set-up activities such as selecting an interface template, organising access layers within the template and uploading personal information to the various access layers. A user may also interact with members of the information portal by creating user groups and shared content.

The various information services 12, 13, 14, 15, 16, 17 implemented by the portal are arranged about the user interactions 11 in the operational overview 10. The computing apparatus 2 performs various information checks for new users. These checks can include verifying the integrity of the data a user has uploaded to their user account 14, retrieving publicly-available user information from independent sources 12 and checking for gaps 16 in data contributed by a user.

Where a user contributes user information that is also publicly available, the server 2 may verify that information by retrieving the same information from another source. The computing apparatus 2 may also prompt the user for permission to access private information from a secure source (such as a bank, insurance company or employer) in order to verify the records that the user has uploaded. The independently sourced information is compared to the user-contributed information to authenticate user information.

Each user may be required to consent to independent verification (by granting permission for the computing apparatus 2 to access independently held private information or another suitable authentication mechanism) before the user is allocated a notional share of the information portal.

The computing apparatus 2 facilitates distribution of user information to third parties. The third parties may include advertisers, marketing companies, health organisations, government agencies, product designers, app developers and other companies or individuals that request user information. The third parties receiving the user information may pay an information fee that is determined from the type, quantity and sensitivity of the data they request. The information fee may also be influenced by a characteristic of the group of users the third party is targeting (e.g. the demographics specified by the third party collecting the information) and what the third party intends to do with the information. For example, the information fee may be reduced if an advertiser has agreed to pay for a targeted advertising campaign through the information portal, or waived completely if a campaign developer is using the information to pitch an advertising concept to other parties.

The computing apparatus 2 may charge an information fee that reflects characteristics of the user group targeted by the third party. These characteristics may include the type of users targeted and/or number of users in the target group. For example, the computing apparatus 2 may charge a relatively higher per-user fee if the third party is promoting luxury goods (such as jewellery or cars) to high income users. The per-user fee may be significantly less if the third party is promoting a staple product (such as basic household items) to a large user group with diverse demographics. The per-user information fee determined by the computing apparatus 2 for a user group may reflect the value of the information being acquired by the third party. For example, a higher per-user fee may apply to targeted user information as the third party may be more likely to derive a sale by directly engaging a user group with desirable demographics.

The computing apparatus 2 can divide user information into two distinct distribution categories. These are ‘aggregated information’ and ‘personalised information’. The primary difference between the categories is that ‘aggregated information’ does not identify individual users (i.e. it does not disclose a user's name or any information that can be used to link the information to an individual). The computing apparatus 2 may generate promotion reports for third parties (such as advertisers or campaign developers) based on amalgamated user demographics. This information may be distributed in an ‘aggregated information’ distribution. The information distributed in an ‘aggregated information’ distribution is typically limited to aggregated user demographics that provide a statistical overview of user characteristics. The computing apparatus 2 has the option to not inform users that their information is being used in an ‘aggregated information’ distribution. However, the reward module may allocate users compensation for the use of their information in an aggregated distribution.

The computing apparatus 2 generally can prompt users to participate in ‘personalised information’ distributions. This enables the user to consent to items of their user information, such as name and addresses disclosed to third parties. The computing apparatus 2 may inform the user about who has requested their information, what information has been requested, the distribution criteria (i.e. why the user has been selected) and the reward they will receive for consenting to the distribution.

The computing apparatus 2 can generate a targeted user profile for each member of the information portal 1. Each targeted user profile comprises some or all of the user information of a user. The computing apparatus 2 may distribute these targeted profiles to third parties such as advertisers or advertising campaign developers for use in advertising campaigns. The computing apparatus 2 can prompt a user for consent to distribute their profile prior to the profile being released to a third party. The computing apparatus 2 may grant users access to their profile and may allow users to restrict the disclosure of aspects of the user information they do not want to be shared.

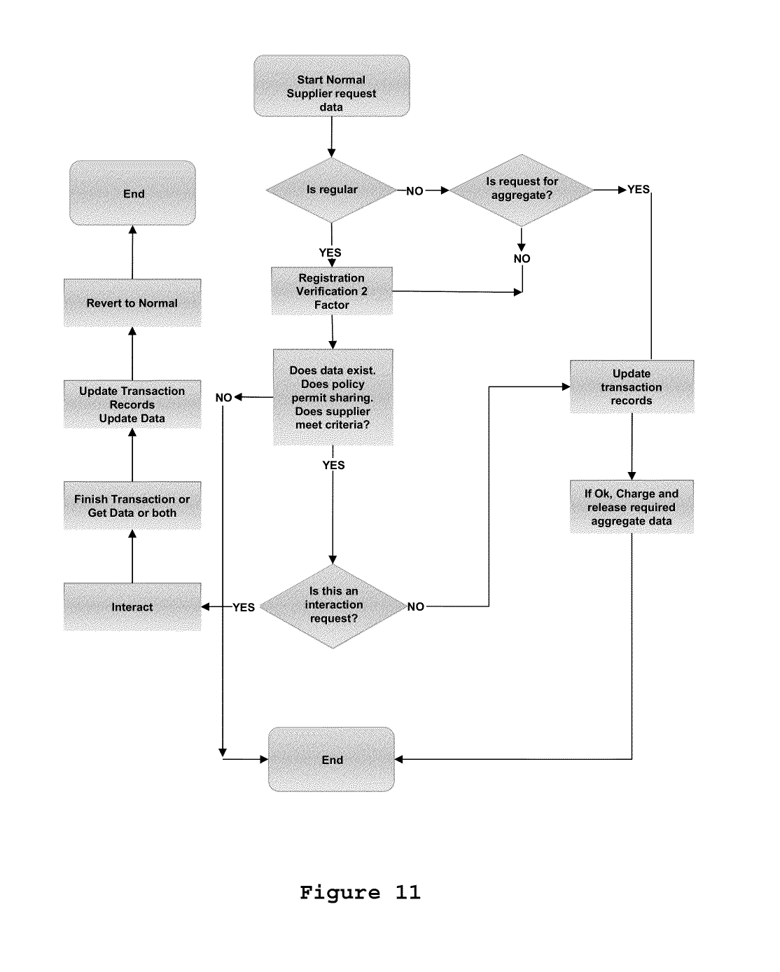

The computing apparatus 2 can store a plurality of promotional accounts that enable third parties to access certain user information. An exemplary third party screening and interaction process is illustrated in FIG. 11. The illustrated process may be implemented by portal 1 before a third party is granted access to a user's information. The screening process involves checking a third party's request (ie. the type of information requested—aggregated or personalised), verifying the third party, and checking whether the information may be released (i.e. whether user set disclosure rules allow for the information to be distributed in the case of personalised information). The interaction process involves monitoring a user's interactions with the third party (such as any transaction outcomes).

The promotional accounts enable certain user information to be transferred between parties within the information portal 1. The computing apparatus 2 can assign to each promotional account a permission level to determine which aspects of user information may be made available to a corresponding third party.

Targeted ‘personalised information’ distributions may be based on a user's demographics (such as the user's age, income, location, occupation etc) or specific contributions they have made to the information portal (such as advising that they are considering renovating their home, shopping for a new car, planning a vacation etc). The computing apparatus 2 can prompt the user to engage directly with interested third parties and may reward the user for direct interactions facilitated by the portal 1.

Personalised information may be associated with a higher information fee than aggregated information. This reflects the sensitivity of the information being distributed and the ability of a third party (such as an advertiser) to target a recipient with desirable characteristics.

The computing apparatus 2 may regularly check user information to identify gaps in user information. These checks may be scheduled periodically or triggered by user activities (such as when a user contributes new information to the portal). The portal 1 may maintain an information template that defines a plurality of desirable information fields. The template may be routinely updated to reflect information that users have contributed to the portal 1. For example, the computing apparatus 1 can update the portal information template when a user contributes information that is not defined in the template. This enables the portal 1 to maintain a record of the potential information a user can contribute. The computing apparatus 2 may use the template as a reference to evaluate the information that each user has contributed to the portal 1 during the routine information checks.

The reward module may maintain a benchmark contribution level that each user is assessed against. The benchmark contribution level is a statistical reference (such as an average or a percentile) that is generated from user contributions of information to the portal. The reward module may use the benchmark contribution level to evaluate the quantity of information an individual user has contributed to the portal. A user's notional share in the portal 1 may be determined from the relative quantity, quality (as determined by the portal based on characteristics of the data), method of input (direct or indirect) and associated disclosure rules of information the user has uploaded to the computing apparatus 2 (or otherwise contributed to the portal 1). The benchmark contribution level may be used to evaluate the relative quantity of information a user has contributed.

The benchmark contribution level may be dynamically updated to reflect user contribution trends and record membership characteristics. Users are typically registered with the information portal 1. The registration process may result in membership. For example, the benchmark contribution level may increase as the average amount of information users contribute to the portal increases. However, the benchmark contribution level may also be influenced by underlying changes to the portal's membership characteristics. For example, benchmark contribution level volatility may indicate emerging membership trends (such as an increase in new memberships reducing the benchmark contribution level). Reduced volatility may represent increasing membership maturity or contribution stagnation.

The reward module may adjust each user's notional ownership share to reflect changes in the benchmark contribution level. Tying each user's notional ownership share to the benchmark contribution level can create a comparative remuneration arrangement that may reflect the relative contribution a user has made to the portal. The reward module may update each user's notional share periodically (as the benchmark contribution level changes) or dynamically as the user contributes information to the portal. The reward module may maintain an official notional ownership share that is updated periodically (with the benchmark contribution level) and a notional ownership indicator that is updated each time a user updates the information they have stored on the computing apparatus 2 (such as adding information, removing information or altering disclosure rules).

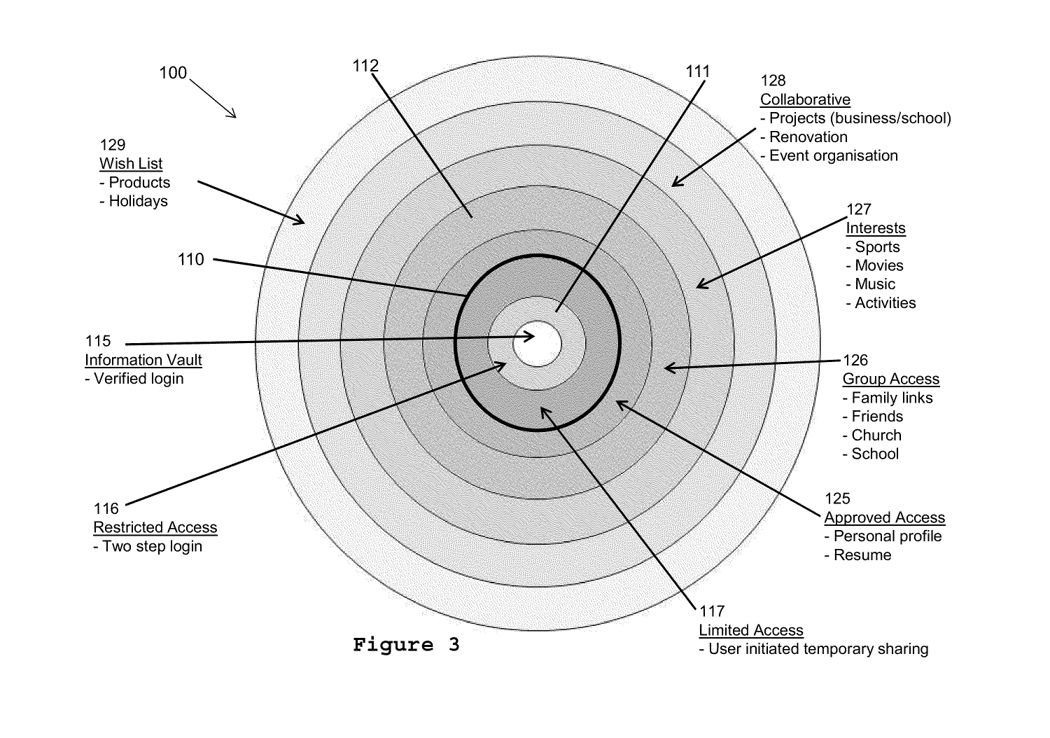

The interface supported by the computing apparatus 2 can be the primary gateway for user interaction with the information portal. The interface facilitates entry of user information and assignment of a disclosure rule to individual information entries. The interface also may enable individual users to check their notional ownership share, evaluate the information they have contributed to the portal and participate within the portal community. A schematic representation of how a user's information may be presented to the user through the interface is illustrated in FIGS. 3 to 7. The illustrated interface is a structured template that a user can use to organise their information and apply disclosure rules.

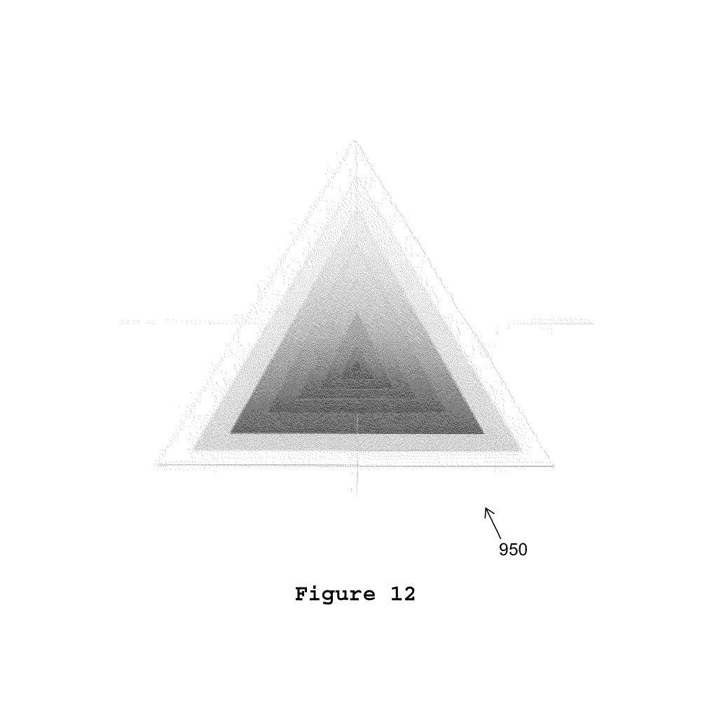

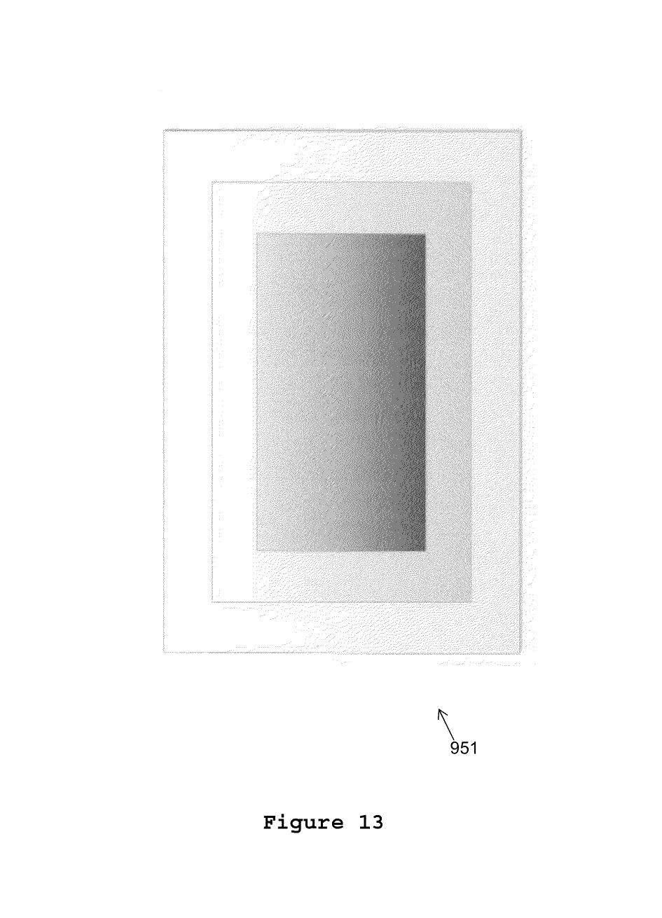

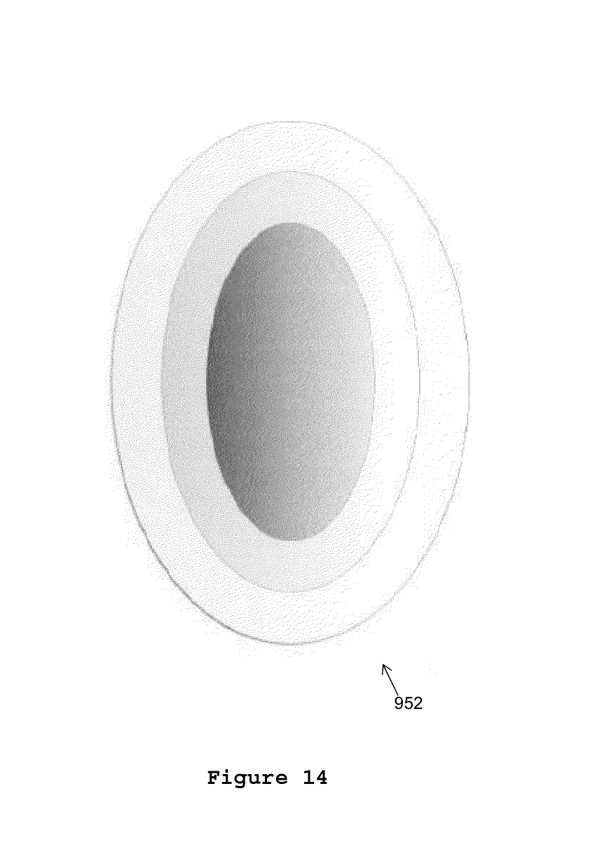

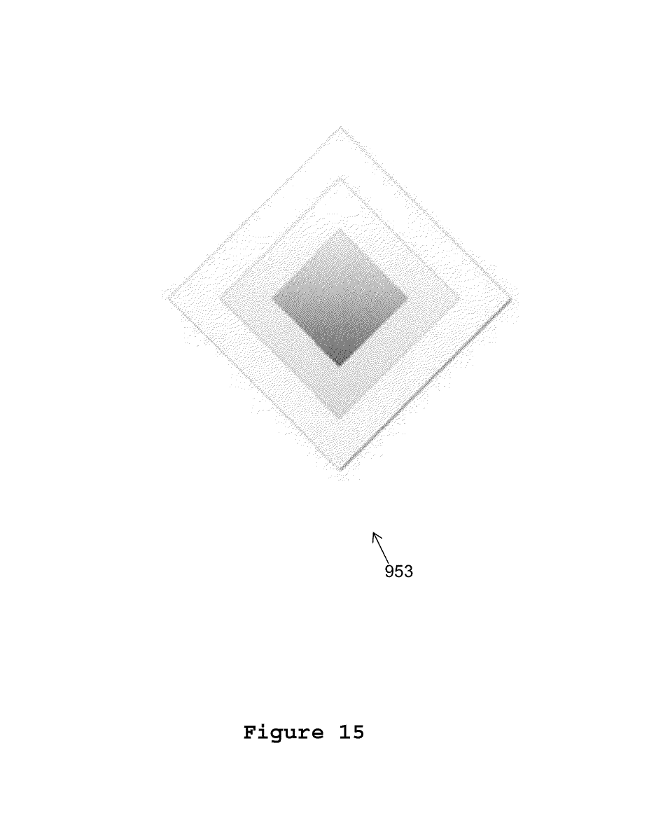

The embodiment of the interface 100 illustrated in FIG. 3 schematically depicts the general structure of user information within the portal 1. The interface 100 comprises a plurality of concentric circles (i.e. they have a common centre). The circles graphically represent disclosure rules that can be attributed to a user's information. Some alternate interface configurations are illustrated in FIGS. 12 to 15. Each interface 950, 951, 952, 953 comprises a series of concentrically arranged zones that define different access layers (a graphical representation of the graduated disclosure rules). The interface 950 illustrated in FIG. 12 is constructed from a plurality of triangles. The interface 951 illustrated in FIG. 13 is constructed from a plurality of rectangles. The interface 952 illustrated in FIG. 14 is constructed from a plurality of ellipses. The interface 953 illustrated in FIG. 15 is constructed from a plurality of squares.

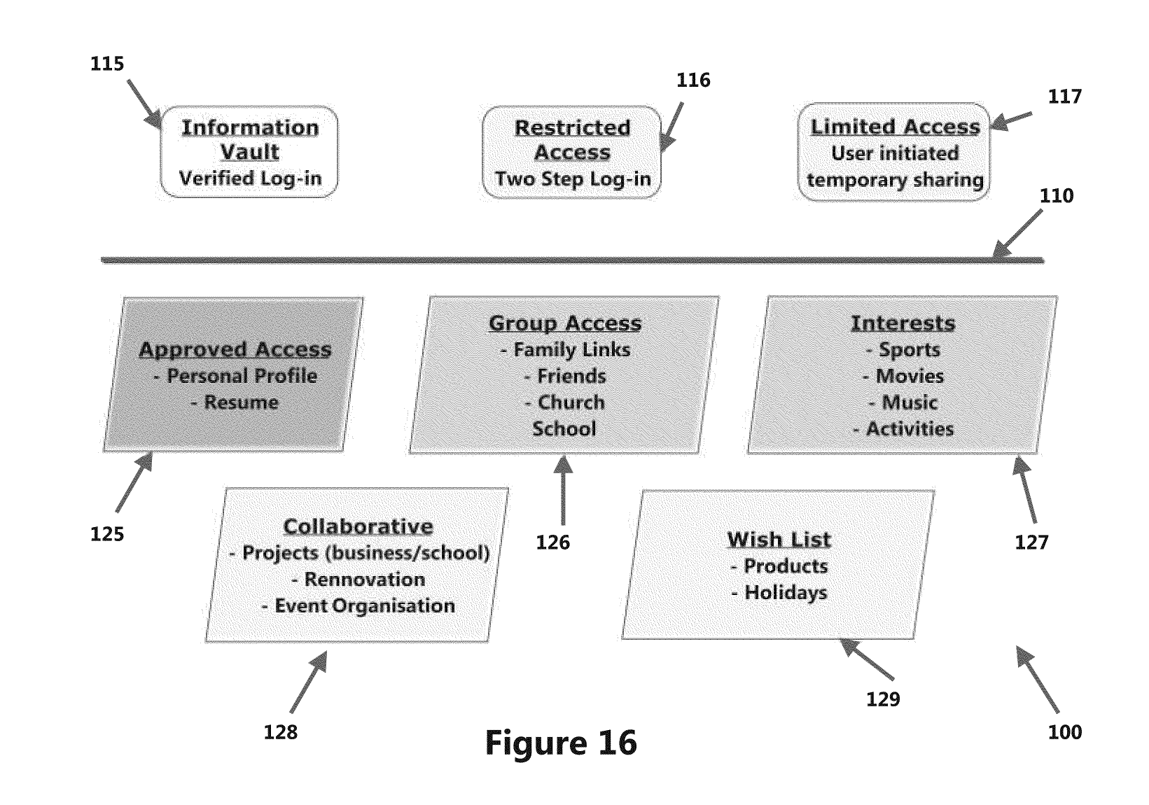

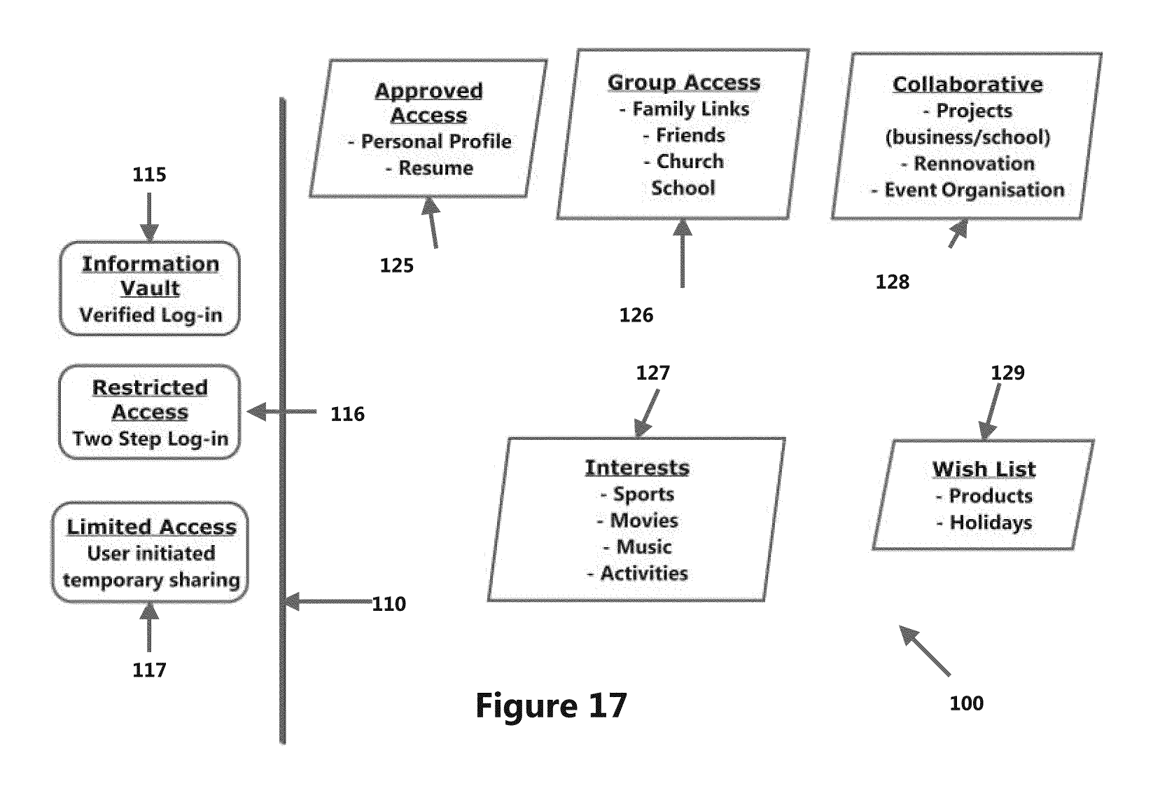

The concentric representations in FIGS. 3 to 9 and FIGS. 12 to 15 are examples of graphical representations of, in these example cases, a series of concentrically arranged zones that define different access layers (a graphical representation of the graduated disclosure rules). Actual presentation of the various functionalities of the portal as they appear to a user may take any presentation form. Examples of some other embodiments with different graphical presentation to a user of Portal 1 are presented in FIGS. 16 and 17.

In general any graphical layout or presentation form may be used to deliver any functionality of any method of embodiments of the invention. In general any combination may be used. Presentation templates similar to FIGS. 3 to 9, 12 to 17, or any other may be provided by the Portal 1. Any user defined template may also be offered to deliver functionality provided by embodiments of the invention.

An example of the function and operation of the user interface is described in relation to the circular information representation illustrated in FIG. 3. The function is equally applicable to other interface configurations (such as those illustrated in FIGS. 12 to 17). Some geometric terms are used to define attributes of the circular interface (such as annulus). Similar zones may be defined in other interfaces (such as those illustrated in FIGS. 12 to 15) with different geometrical characteristics (i.e. the corresponding zones of the triangular interface 950 illustrated in FIG. 12 are not annular). However, the function and operation of these equivalent zones is the same as described for the circular interface 100.

In FIGS. 16 and 17 the same reference numerals as in FIG. 3 have been used to indicate the functions and operation of the equivalent zones depicted in circular interface 100 of FIG. 3. The particular graphical representation used may be determined by a user of Portal 1.

Each circle encloses an information zone. The respective information zones represent distinct disclosure rules that may be assigned to an item of user information. The information zone 115 at the centre of the illustrated interface 100 is defined by the circular area of the innermost circle (the ‘first’ circle). The information zones of the remaining (subsequent) circles are annular. The annular information zones 116, 117, 125, 126, 127, 128, 129 are delimited by the circumferences of adjacent circles (i.e. the annulus defined between consecutive circles). For example, the second information zone 116 is the annulus delimited by the circumference of the ‘second’ circle (the circle immediately after the innermost circle) and the circumferences of the innermost (‘first’) circle.

The interface 100 illustrated in FIG. 3 is a simplified graphic representation of the general data structuring implemented by the portal 1. The actual graphical presentation of such structures on a portal can vary. The concentric organization of the interfaces 100 to 500 illustrated in FIGS. 3 to 7 represents the progressive disclosure rules available to a user when they contribute information to the portal 1.

Each user can use the interface to access their user information retained by the portal 1. The interface enables the user to manage their information, personal settings and interactions. The structure of a user's information within the interface may reflect the disclosure rule assigned to the information.

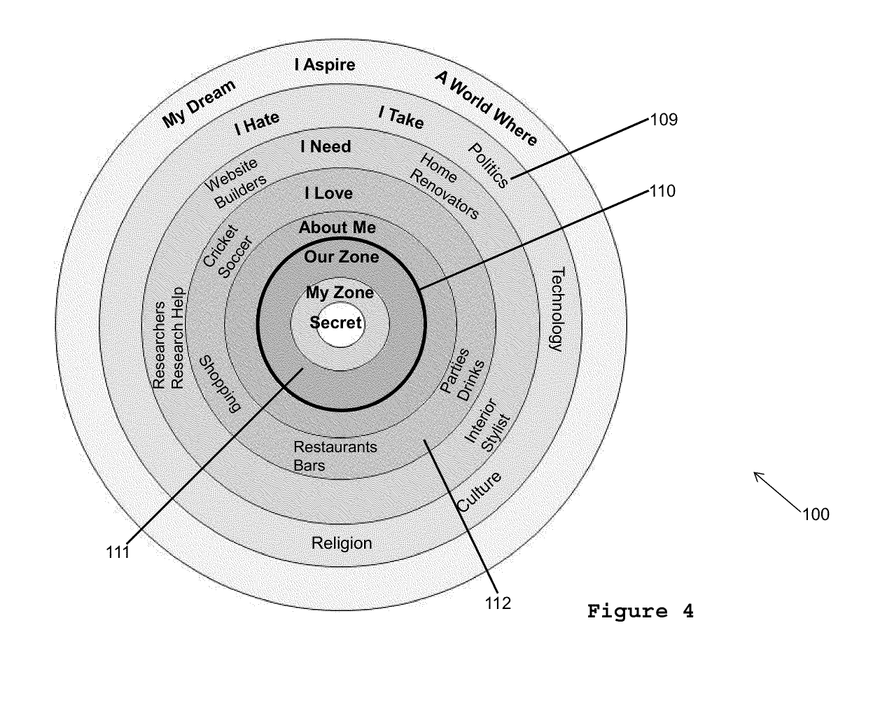

The schematic interface 100 is reproduced in FIG. 4 with links to various forms of user information. The information links 109 are disposed in positions that reflect the corresponding disclosure rule of the associated information. Each link 109 may redirect a user to another interface where the selected information is presented in a suitable format. For example, selecting the ‘parties/drink’ link may redirect a user to a portfolio of photos they have uploaded for social events.

The portal 1 may present new users with a structured interface template, such as a template with concentrically arranged information categories. The structure of the template is intended to provide users with an intuitive guide to structuring their information. Users may alter the appearance of their personal portal interface to reflect their personal preferences. Some of the interactions that a new user may have with the portal interface are summarised at the core 11 in FIG. 2, for example selecting or modifying templates for information representation, organising information into access layers, contributing information, allocating disclosure rules, creating groups, allocating permissions, creating or allowing access to shared content etc.

Each user account may contain generic user information fields that identify types of information a user may contribute to the portal 1. Each generic user information field may be confined to a single information zone so that all the user information associated with the field is assigned the same disclosure rule. The portal interface may enable users to modify the generic information fields and create personalised information fields.

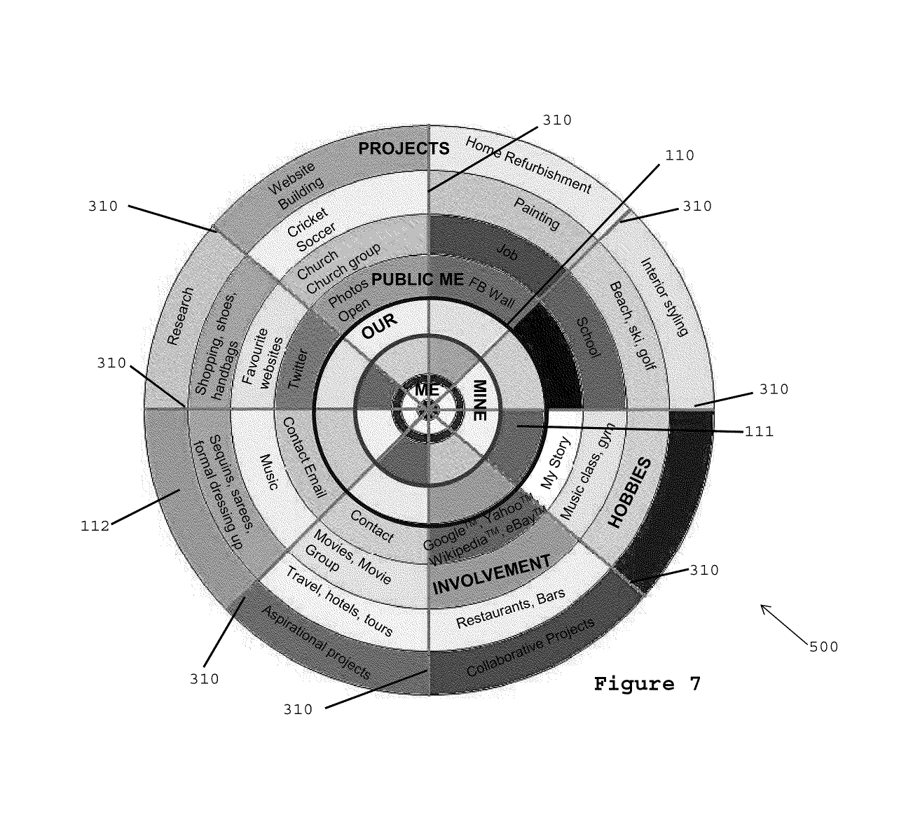

An example interface 500 with defined information fields is presented in FIG. 7. The information fields illustrated in FIG. 7 are a combination of generic and user-defined fields. Each field is contained within an individual information zone. The boundaries of the information fields are delimited by the concentric information zones and a set of radial dividers 310 that extend from the centre of the interface 500 to the outer circumference. The dividers 310 dissect each of the information zones in the illustrated embodiment. The information field dividers may be limited to individual information zones in some embodiments to facilitate greater customisation.

The generic information fields that populate new interface templates are defined by the computing apparatus 2. The computing apparatus 2 may derive the generic information fields from the information that existing users have contributed to the portal 1. The computing apparatus 2 may also assign each of the generic information fields a disclosure value. The disclosure value typically reflects the worth of the corresponding information to the portal.

The generic information fields and associated disclosure values are intended to indicate to new users the categories of information they can contribute and the relative reward they may receive. A user may populate the generic user information fields by uploading the corresponding information, rearranging the fields within the information zones to reflect their disclosure preferences, or removing the generic fields. Each user account may allocate a disclosure rule (which can be set by the user) to each of the generic user information fields. Changing the disclosure rule for a generic information field alters the information zone that the field is linked to (ie. reducing the disclosure rule of a generic field will shift the field toward the centre of the interface 100 illustrated in FIG. 3).

In an alternative example, a user may prepare information for contribution to the portal by the information first being automatically allocated to generic categories (for example, based on meta data associated with each piece of information, such as each photograph, file or data entry field) and graphically represented in a form such as shown in FIG. 3. The user may then re-allocate information to different categories. The user may also be able to add or remove categories, for example additional categories may be selected from a list and information moved to the added category. The user may be restricted from removing a category that has information allocated to it, for example the user must reallocate all information to other categories before a category may be removed. The user may also allocate disclosure rules to each additional category. For example, the user may select predefined disclosure rules from a list, or complete a set of fields to build a disclosure rule. Two or more predefined disclosure rules may be combined to build a new disclosure rule for a category. Alternatively disclosure rules may be defined using mathematical or Boolean operators, or scripts. Any one or more alternative methods for allocating disclosure rules may be enabled in different embodiments of the invention. A user may be able to select the method used for defining disclosure rules. The user may perform these customisation and disclosure rule allocation steps before contribution of the user information to the portal and making information available via the portal in accordance with the disclosure rules. It should be appreciated that embodiments of the invention allow a user to flexibly and precisely control access to the information they have contributed to the portal 1 via disclosure rules.

The portal reward module may determine a reward value for each information entry that a user contributes to the portal 1. The reward value for an information entry typically reflects the sensitivity of the information that the user has contributed (as determined by the portal 1) and the disclosure rule that the user has allocated to the information.

The reward module may assign disclosure values to specific user information categories (such as a user's passport number, date of birth, political alignments etc) to maintain a consistent reward standard across the portal. The disclosure value is determined by the reward module and reflects the sensitivity of the information the user has contributed to the portal 1.

The reward value attributed to a particular information entry may be determined from the disclosure value for that information. The reward module typically applies an appropriate scale to the disclosure value to determine the reward value. The scale reflects the disclosure rule that the user has assigned to the corresponding information. The reward allocation and tracking process implemented by the reward module is represented in FIG. 2 branch 13.

The example of an interface 100 illustrated in FIG. 3 has eight defined information zones that each represent a disclosure setting. The respective information zones link to user information that has been assigned a corresponding disclosure rule. The eight zones illustrated in FIG. 3 are divided into two fundamental clusters 111, 112. The inner cluster 111 contains three ‘closed’ information zones 115, 116, 117 that link to user information with a ‘closed’ disclosure rule (i.e. a graduated scale from information that a user does not want to disclose at all to information that a user wants to tightly control access to). The outer cluster 112 contains five ‘open’ information zones that link to user information with an ‘open’ disclosure (ie. a graduated scale from information that a user is sometimes willing to share, to information that a user is more routinely willing to share with other parties, through to information a user wants to remain publicly assessable for a period of time or for all the time, through to information a user actively seeks to make widely publicly available or information seeking publicity).

The clusters 111, 112 are separated by a thickened division line 110 that coincides with the circumference of the ‘third’ circle. In FIGS. 16 and 17 the cluster including the ‘closed’ information zones is displayed in a region of the display divided from the other zones by a dividing line 110. In FIG. 16 the ‘closed’ zones are located in an upper region of the display and in FIG. 17 to one side of the display. It should be appreciated that other alternative representations could be used, for example the ‘closed’ zones may be surrounded by a border.

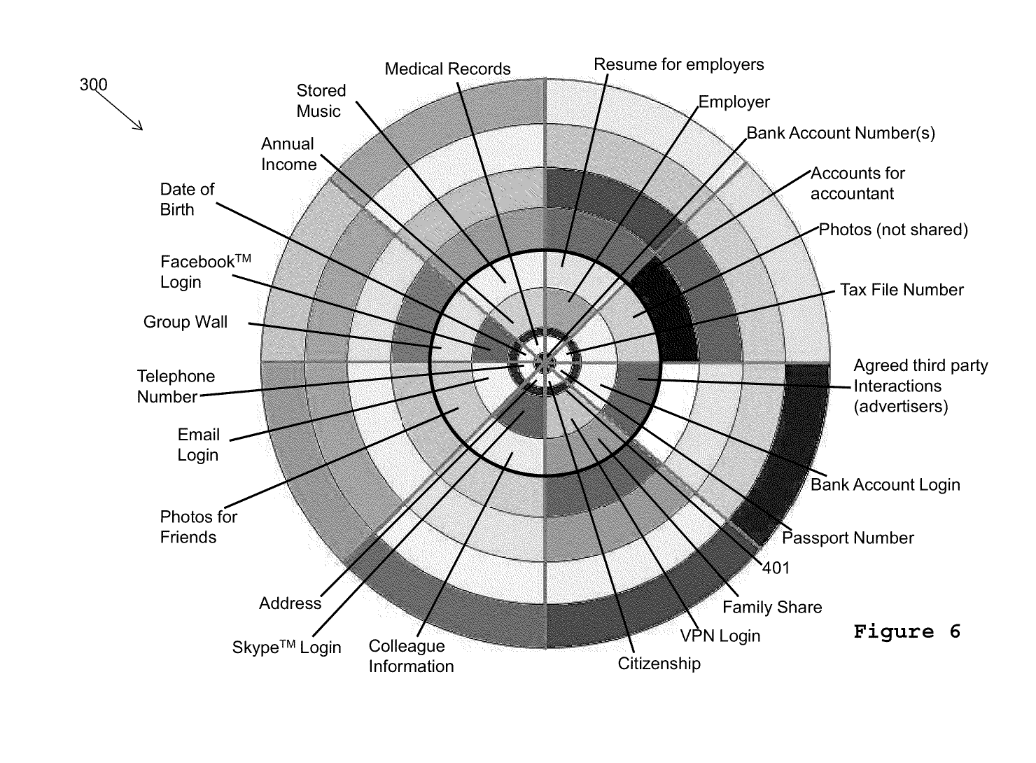

The three information zones 115, 116, 117 enclosed by the division line 110 have progressively more secure data protection provisions. Access to these zones is typically restricted to reflect the sensitivity of the associated information. A user may modify the security settings to reflect their personal preferences. Some types of information that a user may decide to link with the respective zones 115, 116, 117 are depicted in FIG. 6. The illustrated information includes bank account information, login details for third party websites, and identification records (such as passport numbers, addresses and phone numbers). The information zone that a user selects for a particular information entry typically reflects the sensitivity of the user information as judged by the user. The most sensitive information is typically allocated at the centre of the interface 300.

The outermost ‘closed’ information zone 117 (ie. the outermost zone enclosed by the thickened division line 110) links to user information with limited access. This information zone 117 is denoted ‘Limited Access’ in the drawings. The information linked with the limited access zone 117 is typically password protected. A user may share information attributed to this zone with trusted parties by granting the other party access through the portal 1 or distributing an access key (such as a temporary password). The computing apparatus 2 may also prompt a user for permission to distribute the information stored in the outer ‘closed’ information zone with trusted third parties (typically for some reward).

The intermediate ‘closed’ information zone 116 typically links to information that a user does not want to share with third parties. This zone 116 is denoted ‘Restricted Access’ in the drawings. The information linked with the restricted access zone 116 may have more secure access provisions (such two factor authentication with account number and password and/or one time password/security token) and is generally not accessible by third parties.

The innermost information zone 115 contains a user's most private data. This zone 115 is denoted ‘Information Vault’ in the drawings. The information linked with the information vault 115 may also be protected by privacy laws. The computing apparatus may require auxiliary user verification (such as an SMS code or USB dongle) before granting access to information a user has associated with this information zone 115. The access to this zone may in some cases be by highly secured two or three factor authentication or other highly secured methods. In some cases a physical verification or pre-verification of the user and his/her identity documents by approved or authorised agents may be required before multiple factor authentication credentials or such highly secured log-in credentials may be issued to the user. For example such verification or pre-verification may be a necessary step before any notional shares may be actually effected into any other instrument rewards. The portal may be arranged such that a user cannot share information classified with a ‘private’ disclosure rule with other users through the information portal.

The information zones 125, 126, 127, 128, 129 comprising the outer cluster 112 denote different ‘open’ information categories. These zones are illustrated outside the division line 110 in FIG. 3. The user information linked to the outer cluster 112 information zones may be ‘public’ information (information that is shared without restriction) or ‘controlled access’ information (information that is shared with affiliated members or approved groups). These information zones also have progressive access requirements.

An ‘Approved Access’ information zone 125 is disposed toward the centre of the outer cluster 112, adjacent the inner cluster 111. The inner boundary of the approved access zone 125 coincides with the division line 110 between the respective clusters 111, 112. The information linked to the approved access zone 125 is typically shared with individual users or user groups that are specified by the user. This information may include personal profiles and resumes that are shared with potential employers or business partners.

The approved access zone 125 is enclosed by a ‘Group

Access’ zone 126. The information linked to the group access zone 126 is typically shared with other portal members that are affiliated with the user. This information may include photos, written communication between users and group affiliations (such as schools, religious groups and family links). The portal 1 may enable individual users to control their affiliations with other users. This typically involves enabling individual users to initiate affiliation requests, prompting users to validate affiliation requests before granting access to a group access zone 126 and allowing users to terminate affiliations.

The group access information zone 126 and the approved access information zone both link to ‘controlled access’ information. This is information that a user may share with other users, but is not publicly shared (‘open’) information. The computing apparatus 2 may prompt a user for permission to share personal ‘controlled access’ information with third parties.

The remaining three zones 127, 128, 129 of the outer cluster 112 are ‘public information’ zones. Information linked to these zones is not secured by the computing apparatus 2. The respective zones 127, 128, 129 define categories of user information. The information associated with these zones 127, 128, 129 may be distributed to third parties without explicit user consent.

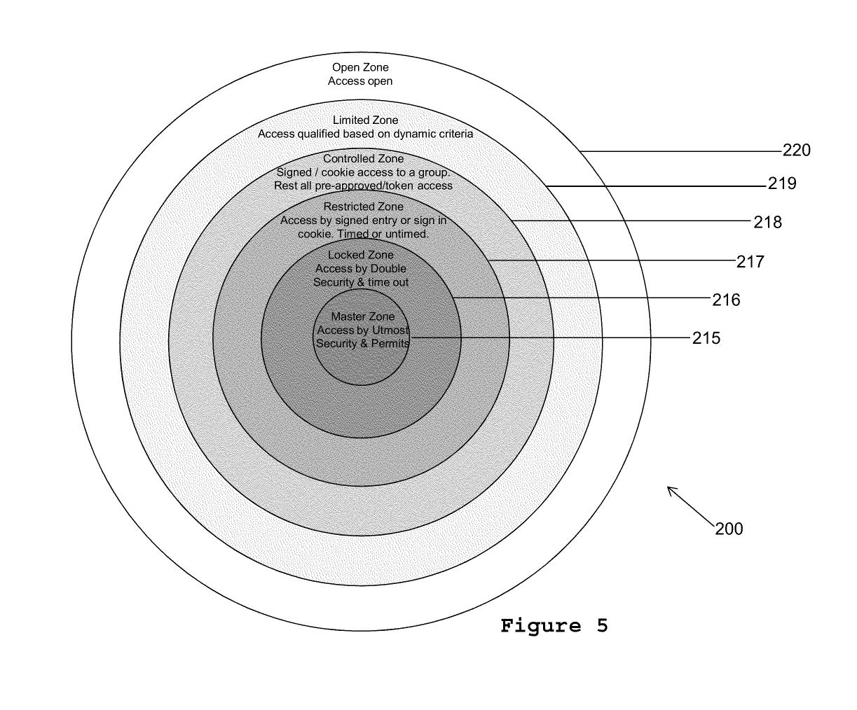

Another structured user interface with defined information zones is presented in FIG. 5. The illustrated interface 200 has six information zones with graduated security provisions. The zones 215, 216, 217, 218, 219, 220 are shaded in the drawing. The shading of each zone in this example reflects the security provisions associated with the respective zone. The ‘master zone’ 215 disposed at the centre of the interface has the strictest security provisions. This zone 215 is depicted with the darkest shading. The security provisions for the information zones reduce radially from the centre of the interface 200. This is reflected graphically in the figure by a reduction in shading darkness. A similar colour scheme may be applied to the interface template adopted by the portal 1.

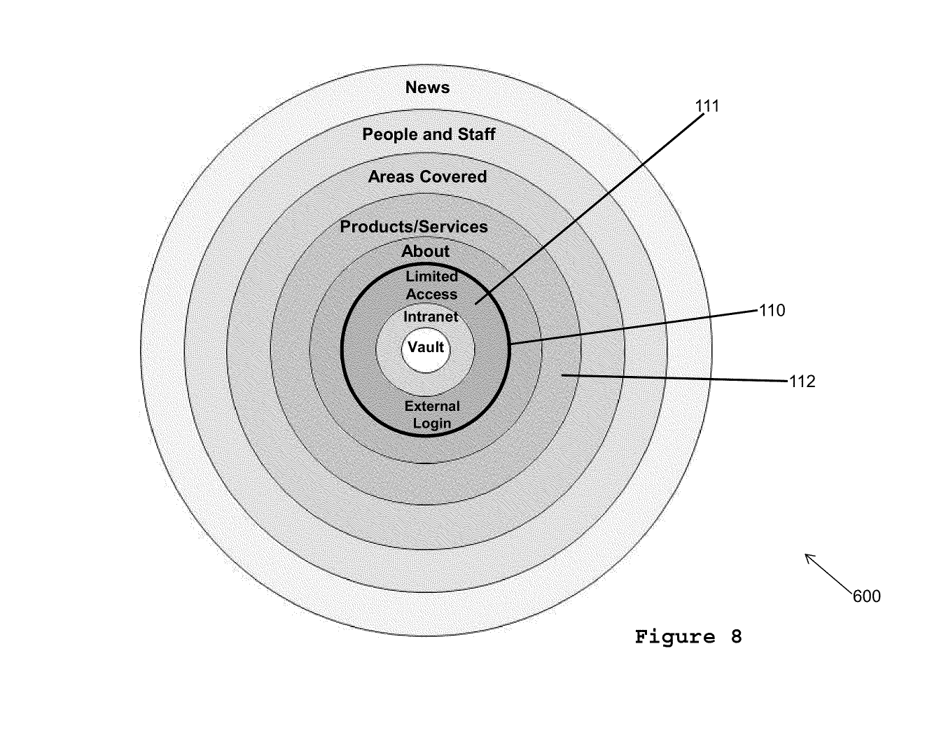

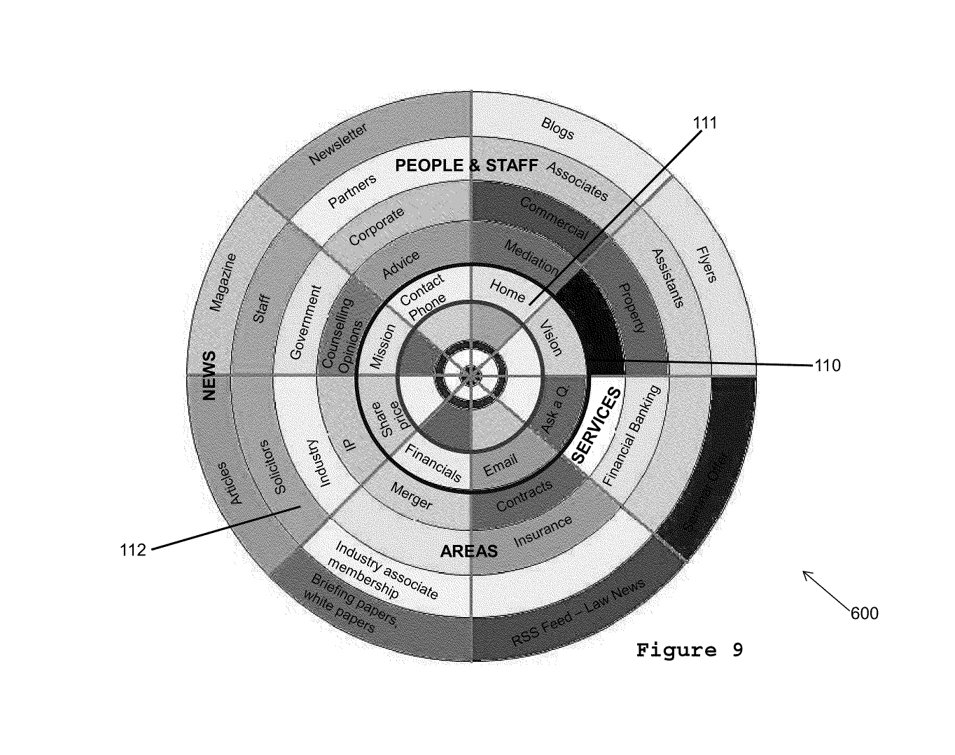

The portal 1 may also be used to enable an organisation to manage their information. A structured interface 600 for an organisation is illustrated in FIGS. 8 and 9. The interface 600 has similar attributes and structure to the individual user interface 100 illustrated in FIG. 3.

Members within an organisation (such as employees) may be granted access to various information zones or information fields depending on their role and authorisation level within the organisation. Each member of an organisation may be allocated a dedicated interface that enables them to access their own information and the information they need to perform their role.

The information portal may also provide a secure gateway that connects users to third party websites. Such a gateway can enable users to access third party websites through the portal interface. The computing apparatus 2 may facilitate automatic user authentication for third party websites using the user information stored in a corresponding user account within the portal. The gateway may also incorporate additional security provisions that protect the exchange of user information with the third party website.

The sever 2 may record user information that a user shares with third party websites through the gateway. Such information is stored in computing apparatus memory in association with a corresponding user account. The portal interface may enable a user to disable the monitoring function and may initially prompt a user and explain that their information exchange is being monitored. The computing apparatus 2 may use the information that a user exchanges with a third party website to verify the information that the user has contributed to the information portal 1. The computing apparatus 2 may compare the information a user has contributed to the portal 1 with the information the user shares over the gateway.

The reward module may allocate users a reward for information that is retrieved during third party interactions conducted through the portal 1. Reward-eligible third party interactions include information exchanges that are conducted through the portal gateway and campaign interactions. Campaign interactions that are rewarded by the portal reward module may involve direct interaction with a campaign organiser (such as an instant message dialogue, video conferencing or completing a campaign transaction).

The user information contributed by a user to the portal 1 may be interpreted by the computing apparatus 2 and used to customise the user experience of the portal. Some examples of how the portal 1 may facilitate interactions and adapt experiences based on user information are presented here.

The computing apparatus 2 may customise advertisements presented to each user within the portal interface based on a user's information. This is represented in FIG. 2 by branch 15. Targeted advertising produces greater placement accuracy for advertisers and increases the relevance of listings to the targeted user.

Public user information (such as items in a user's wish list 129 or collaboration zone 128) may be distributed to other users or third parties with complementary objectives. For example, the portal 1 may organise an interaction between a user with a particular holiday destination specified in their wish list 129 and travel agents that are promoting specials for that destination.

The portal 1 may distribute custom user surveys to extract information from users. The portal 1 may initiate targeted surveys to refine the services presented to a user and provide more accurate information to campaign operators. The computing apparatus 2 may also generate general surveys to compensate for gaps in a user's information and improve passive interactions (such as the advertisements that a user is exposed to through the portal interface 1). This is represented in FIG. 2 by branch 16.

The computing apparatus 2 may generate targeted surveys to elicit information from users with demographics and interests that reflect the objectives of a scheduled campaign. The information received from a user in response to the survey may be used to characterise the user and evaluate their suitability for a particular campaign. The information received from individual users may also be used to identify general demographics that the campaign operator wants to target, enabling the portal 1 to passively filter potential campaign participants. For example, the computing apparatus 2 may prompt a user to identify particular regions of a travel destination they are interested in visiting, the type of accommodation they prefer and their cost expectations before initiating any third party interactions. An individual user's cost expectations may be used to filter other potential participants with a similar household income without engaging the users directly.

The portal 1 may generate a standard feedback form or survey for products or services. The form or survey may be product and/or service neutral and may contain generic questions that enable a user to document user experiences. Some questions that may be included in the form or survey include:
1. A rating of the user's satisfaction with the product/service,
2. A rating of the user's satisfaction with the customer service associated with the product or service, and
3. An assessment of whether the user would recommend the product/service to others.

The reward value for the information that a user contributes to the portal 1 may be converted to a notional share in the portal 1 (i.e. an ownership stake in the company that owns or administers the portal 1) or another reward (such as a voucher or coupon). This determination typically depends on the type of information the user has contributed. The reward module may allocate each user's notional share of the information portal in proportion to the amount and sensitivity of the information they have contributed to the portal 1.

The reward module may also reward users for their interactions. Rewards may be allocated for engaging with third parties campaigns, completing customised surveys, contributing reviews and other tasks. Interaction rewards may not contribute to a user's notional ownership share (except where valuable information is acquired).

The notional ownership share determined by the reward module for each user may be expressed as a percentage share of the company that owns or administers the information portal 1, a nominal quantity of shares in the company that owns or administers the information portal 1 or another suitable ownership representation of the company that owns or administers the information portal 1. The notional shares in the information portal 1 allocated by the reward module may be a notional ownership stake in the company that owns or administers the information portal 1. The notional ownership stake may be converted to an actual ownership stake at a later stage if the laws of the jurisdiction that the user abides in permit the allocation of an actual ownership share to the user. The share may be voting share, non-voting share or any other suitable instrument that represents a stake in the information portal 1. The reward module may prescribe an ownership cap that limits the absolute notional ownership share that may be allocated to a user.

The information portal 1 may also facilitate interactions that are not conducted directly through the portal interface. Such auxiliary services may be implemented by the portal 1 and may include anonymous transaction facilitation and proprietary reward scheme exchanges.

The information portal 1 may implement an anonymous transaction framework that facilitates financial payments from verified members to third parties. The framework may enable verified members to conduct a transaction without disclosing their sensitive information (such as the user's name, address or birthday). The system protects a user's sensitive information and prevents third party aggregators from compiling transaction information for the user. The portal 1 may authorise the member's financial institution to make a payment to the third party (using the information the member has contributed to the portal 1) and authorise the third party to complete the transaction by guarantee payment.

The portal 1 may issue users with an identification instrument. The identification instrument facilitates implementation of the anonymous transaction framework by enabling third parties to submit a transaction request without specifically identifying the user. The physical identification instrument may be a card with secure verification (such as holographic verification), a membership number and access code or another suitable mechanism.

The portal 1 may also operate an exchange for proprietary reward schemes (such as airline air miles). The reward exchange may allow users to substitute the reward points they have accrued with a third party for a virtual currency governed by the portal reward module. The portal may also allow users to exchange reward points between incompatible third party reward systems (such as swapping air miles for points in a loyalty program operated by a supermarket chain or pharmacy).

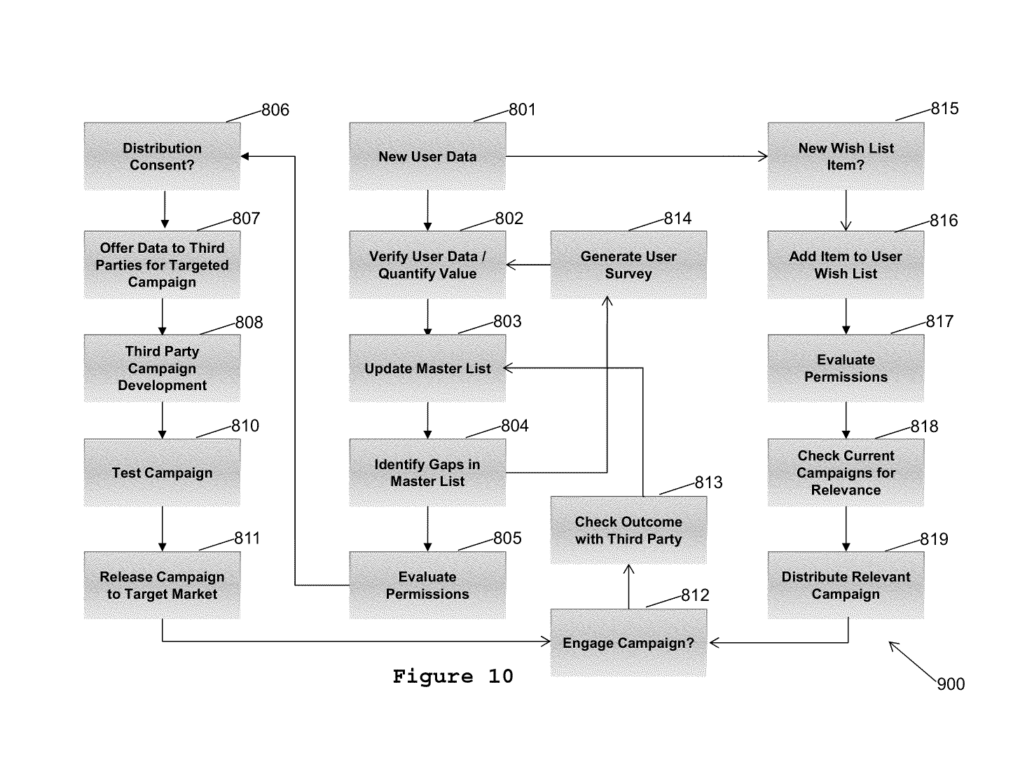

A data management routine 900 is illustrated in FIG. 10. The computing apparatus 2 may implement such a routine to validate and distribute user information. The routine initiates when the portal 1 receives new user information in step 801. This may be information that a user uploads to the computing apparatus 2 or information that the portal 1 obtains from another source. The computing apparatus 2 initiates a verification procedure in step 802 to check the authenticity of the new user information. The user information is discarded if the computing apparatus 2 determines that it is not authentic.

The computing apparatus 2 updates the user's master record (i.e. the information linked to the user account within the portal computing apparatus) in step 803 if the new user information is validated. A data check is then initiated in step 804 to check for gaps in the user information. The computing apparatus 2 may prompt a user to enter additional information if the data check identifies missing information. This is represented by the generation of a user survey in step 814. Any additional information that the user contributes in the survey is entered into the master record and another data check 802 is initiated.

The computing apparatus evaluates the disclosure rules that the user has allocated to the new information in step 805. The disclosure rule dictates how the information is subsequently handled. The computing apparatus may incorporate the information in an aggregated promotion report irrespective of the disclosure rule assigned to the information (as the user is not identifiable from the report). The aggregated promotion reports are compiled using information from a plurality of users.

The computing apparatus evaluates the disclosure rule a user has assigned to the information in step 806. The computing apparatus may offer the information to third parties if the user has allocated a disclosure rule that permits distribution. The computing apparatus may filter user information to meet third party criteria before distributing the information. This increases the value of the information for the third party by allowing them to target users with desirable characteristics (such as income, location and preferences).

The computing apparatus then invites the third parties to engage the targeted user group in a promotional campaign. This is depicted in step 808. The third parties may test the campaign by restricting the initial distribution to a limited user group (step 810) before the full release (step 811). The computing apparatus may monitor campaigns that are distributed through the portal 1. The reward module may reward users for participating in third party campaigns and engaging the third parties that operate the campaigns. This is depicted in steps 812 and 813 of the flow chart 900.

The new information received by the portal 1 in step 801 may also be used to evaluate a user's suitability for existing campaigns. This is illustrated as another branch of the flow chart 900. The computing apparatus 2 checks the type of information received by the portal 1 (step 815), categorises the information (step 816) and evaluates the associated permissions (disclosure rules) before checking for existing campaigns (step 818). If any of the preliminary steps (steps 815 to 817) identify that the information is not suitable for distribution (i.e. the information category is not suitable or the disclosure rules assigned by the user do not permit the information to be distributed), the computing apparatus may not perform a campaign check (step 818). The portal 1 may distribute existing campaigns to a user (step 819) if the user's information indicates that the user is suitable for an existing campaign (following the computing apparatus conducting a campaign check in step 818).

The information portal 1 may enable users to engage third parties without disclosing personal information that may identify or characterise the user. For example, a user may not want to disclose their location (such as the country they live in) to avoid price discrimination. A user may also want to avoid third parties creating a record of their transactions.

The portal 1 may issue a user an anonymous instrument to facilitate anonymous user interactions. The instrument may include an email address, a pseudo-name or an artificial identity. The portal 1 may act as an intermediately between the user and the third party during the interaction to maintain the user's anonymity. This may include routing correspondence between the third party and the user and providing a transaction buffer (such as a generic account that payments are made from or an artificial delivery address).

Such anonymity may be provided by a variety of methods any one or more of which may be used in conjunction or on its own.

Partial anonymity may be provided where an action or interaction requires part identification only, for example where one part of the user data is real and other parts of identity or characteristic user data remain anonymous or artificial or arbitrary.

Anonymity may be provided by creation of ‘anonymous user email’ address for example. Such anonymous user email address may be created by providing real user with an arbitrary or artificial (as opposed to real or true) email address generated by the portal, for example, where the true or real email address owner may remain anonymous forever or for a period of time or for one time through providing the user respectively with “pseudo email address” or “limited time email address” or “one time email address” for a particular interaction, event, purpose, recipient(s), exchange, group, list, third party, other portal, other goods provider, other service provider, marketer, advertiser or other data user or data responder or one or more of those or in respect of any other user or any third party whatsoever.

Yet other ways in which such anonymity may be provided is by creation of ‘anonymous user name’ for example. Such anonymous user name may be created by providing real user with an arbitrary or artificial (as opposed to real or true) user name generated by the portal, for example, where the true or real username may remain anonymous forever or for a period of time or for one time through providing the user respectively with “pseudo user name” or “limited time user name” or “one time user name” for a particular interaction, event, purpose, recipient(s), exchange, group, list, third party, other portal, other goods provider, other service provider, marketer, advertiser or other data user or data responder or one or more of those or in respect of any other user or third party whatsoever.

Anonymity may be provided by creation or generation of artificial or arbitrary user data (as opposed to real or true user data) for any user data whatsoever. Data so created may then be associated with other artificial or arbitrary user data so created or with anonymous user name or anonymous user email for example. For example this may be done by creation of artificial or arbitrary user data such as the wealth of the user and then attaching that data to the anonymous user name or anonymous user e-mail address created as above.

Yet other examples of such artificial data that can be attached to artificial other data or to anonymous user name or email address or other such anonymous characteristic data by which websites or portals identify user include, for example, creation of an artificial photo or artificial or anonymous user account, artificial or anonymous character/avatar, artificial or anonymous voice, looks, appearance, personality, user's generic or personal details, or for that matter any data in any data field related to the user. Such photo or voice or looks or appearance or personality may be used for visual actions or interactions for example in making audio visual actions or interactions such as for blog photo, Messenger™, voice mail, You Tube™ video explaining to prospective suppliers the user requirements for microwave oven, etc. The artificial character may be used to emulate user in a story board video message for example.

Where part data of the user is correct and part data is artificially or arbitrarily generated as above, only partial anonymity may be available to the user and such partial anonymity may be used for actions or interactions relevant and meaningful to partial anonymity applications. For example, the username may be anonymous and artificially generated as above, however some of the other data used (such as user height and size) may be correct in an example where the user wanted to make an anonymous purchase of a T-shirt or trousers using his partial anonymity but correct fitting sizes through the web portal.

Full or complete anonymity may be used by a user who may want to invite quotations for microwave ovens for kitchen renovations without revealing anything about the user at all. The portal may allow the full transaction to remain anonymous and may only reveal delivery address and name of the user to local store where the real user may pick up real microwave oven. Even the payment made by the user may remain anonymous and may be made by a bulk bank account or credit account held by the portal, with only final charge to the real user being reflected as part of a fully consolidated single item monthly charge made out the real user's credit card.

In this way the user can remain anonymous almost end to end in the whole transaction of microwave purchase through use of anonymous user name or user email address which may be one time user name or one time user email in this example.

The user may however elect to use limited time anonymity using limited time email address. Alternately the user may want to do all such transactions through anonymity and may employ pseudo email address or pseudo user name on a standing basis.

Anonymity may also be applied in disclosure rules for some information, for example a user may allocate a disclosure rule to a category of information (for example body measurements, height, weight, body mass index, dress size etc) which the user will allow to be accessed by a third party without any user identity information. In some embodiments such information may only be aggregated by the portal to ensure the identity of users is obscured. In some embodiments an information category may have two levels of disclosure rules applied, one for known/trusted parties where some user identification information may be released and another for unknown third parties where the user will remain anonymous.

Variations and/or modifications may be made to embodiments described without departing from the spirit or ambit of the invention. The present embodiments and examples are, therefore, to be considered in all respects as illustrative and not restrictive.

This specification describes an information portal with respect to specific embodiments that are illustrated in the drawings. The scope of the claims should not be limited by the preferred embodiments set forth in the examples, but should be given the broadest interpretation consistent with the description as a whole

The word “comprise” (and variations such as “comprises” or “comprising”) is used in the description and claims in an inclusive sense (i.e. to specify the presence of the stated features but not to preclude the presence or addition of further features), except where the context requires otherwise due to express language or necessary implication.

Thus, the described system and method may have other elements or steps in various embodiments of the invention. The purpose of the claims is to define the features which make up the invention and not necessarily all features which a working embodiment of the system or method, to which the invention defines, may have. The system or method defined in the claims may therefore include other elements or steps as well as the inventive elements or steps which make up the invention and which are specifically recited in the claims.

It is to be understood that, if any prior art publication is referred to herein, such reference does not constitute an admission that the publication forms a part of the common general knowledge in the art, in Australia or any other country.

1. An information portal comprising:
a computing apparatus that stores user information, the computing apparatus being connected to a data network, and
a plurality of user accounts stored in computing apparatus memory and accessible through the data network, each user account being linked to a corresponding user's information,
wherein the computing apparatus supports an interface that facilitates user interaction with the information portal, the interface enabling users to enter their own user information and assign a disclosure rule to individual information entries comprising the user information, and the computing apparatus applies the disclosure rules to govern access by third parties to the user information.

2. The information portal of claim 1, wherein the step of allocating a disclosure rule comprises the step of allocating a timeframe for which the information will be available to third parties.

3. The information portal of claim 1 further comprising a reward module that allocates user rewards, the reward module determining the reward allocated to a user based on the information the user has contributed to the portal.

4. The information portal of claim 3 wherein each user account contains generic user information fields that are defined by the computing apparatus, and wherein the computing apparatus is arranged to assign each generic user information field a disclosure value.

5. The information portal of claim 3 wherein each user account allocates a user settable disclosure rule to each of the generic user information fields, the disclosure rules exclusively dictating access to the corresponding user information.

6. The information portal of claim 5 wherein the reward module incorporates the disclosure rule that the user allocates to the information they contribute to the information portal in the reward determination process.

7. The information portal of claim 2 wherein the reward module allocates users a notional share of the information portal for contributing information to the portal.

8. The information portal of claim 7 wherein the reward module determines a nominal quantity of voting or non-voting shares or other ownership instruments shares in the information portal to allocate to each user.

9. The information portal of claim 6 wherein the reward module allocates each user's notional share of the information portal in proportion to the amount and sensitivity of the information the user contributes to the information portal and disclosure rules for disclosing user information to third parties.

10. The information portal of claim 6 wherein the reward module generates a benchmark contribution level that each user is assessed against, and wherein the reward module periodically updates each user's notional share of the information portal to reflect their comparative contribution to the information portal based on the benchmark contribution level.

11. The information portal of claim 1 wherein the computing apparatus stores a plurality of promotional accounts that enable a third party to access user information in accordance with the disclosure rules.

12. The information portal of claim 10 wherein the computing apparatus assigns a permission level to each promotional account, wherein the permission level governs the user information that a corresponding third party has access to.

13. The information portal of claim 12, wherein the permission level governs the time period that the corresponding third party has access to the user information.

14. The information portal of claim 10 wherein the computing apparatus generates targeted user profiles based on information that a corresponding user contributes to the information portal and disclosure rules for disclosing user information to third parties and wherein the computing apparatus prompts a user for permission to distribute a corresponding targeted user profile to third parties prior to the user profile being released for access through promotional accounts.

15. The information portal of claim 1 wherein the computing apparatus supports a gateway that provides access to third party websites, the sever recording information that a user chooses to share with third party websites through the gateway and storing the recorded information in computing apparatus memory in association with a corresponding user account.

16. The information portal of claim 15 wherein the computing apparatus verifies the information a user has contributed to the information portal by comparing the contributed information to information that a user shares with third party websites.

17. The information portal of claim 1 comprising an anonymous instrument that enables the user to interact with third parties without revealing their identity, the instrument being distributed to the third party to facilitate the interaction.

18. The information portal of claim 3 wherein the information portal incorporates a reward exchange module that operates a reward exchange for incompatible third party loyalty schemes.

19. The information portal claim 3 wherein the information portal utilises a virtual currency.

20. The information portal of claim 19, wherein the information portal utilises its own proprietary virtual currency, or a third party's virtual currency.

21. A method comprising:
receiving information from a user,
storing the information in association with a corresponding user account in computer memory of an information portal, and
issuing an anonymous instrument that enables the user to interact with third parties via the information portal without revealing their identity, the instrument being distributed to the third party to facilitate the interaction.

22. The method of claim 21 further comprising issuing the user an interaction email address that one or more of the user and the portal distributes to a third party to facilitate communication.

23. The method as claimed in claim 21 further comprising generating via the portal an artificial identity for use during an interaction with a third party to facilitate communication.
